(19) United States
(12) Patent Application Publication
(10) Pub. No.: US 2012/0215360 A1
(43) Pub. Date: Aug. 23, 2012

(54) PATIENT SUPPORT WITH ELECTRONIC WRITING TABLET

(76) Inventors: Robert M. Zerhusen, Cincinnati, OH (US); Michael M. Frondorf, Lakeside Park, KY (US)

(21) Appl. No.: 13/031,464

(22) Filed: Feb. 21, 2011

(51) Int. Cl. A61G 7/05; G05B 15/00

(52) U.S. Cl. 700/275; 5/658

(57) ABSTRACT

A patient support may, among other things, support a person in a number of positions including a reclined, laying-down and/or seated position. An electronic writing tablet enables the capture of handwritten input in electronic form. The patient support may include one or more electronic writing tablets operably coupled thereto. Handwritten input of a patient or a caregiver may, among other things, be captured at the electronic writing tablet, stored at the patient support, converted into a bed command, communicated to an external system (such as an EMR system or a patient-nurse communication system) and/or displayed at the point of care.

### BACKGROUND

This disclosure relates generally to patient supports that are capable of supporting a person in one or more positions, such as a horizontal and/or a seated position. Such patient supports include beds, stretchers, and other similar devices. Patient supports of this type may be found, for example, in healthcare facilities, homes, and other locations in which care is provided. Examples include the TotalCare®, VersaCare®, CareAssist®, and Advanta™ 2 beds, which are available from the Hill-Rom Company, Inc.

This disclosure also relates to other patient support products, i.e. products that may be used in a patient's room to assist the patient, assist a person in caring for the patient, support medical devices, equipment, liquid or gas supplies, to provide connectivity to electronic devices or systems, or to provide other items or services that may be used during patient care. Such products include overbed tables, headwalls, headboards, service columns, lifts, arm systems, footboard and headboard shelves, care carts, and furniture (such as tables, chairs, couches, and shelving), to name a few.

Electronic writing tablets are devices that are designed to capture in an electronic form input that is handwritten (e.g. writing and/or drawing strokes or markings). The tablets have a surface that provides an instantaneous optical response to the application of pressure thereon by a stylus, a person's finger, or another object. The areas of the surface where pressure is applied visually contrasts with the background color of the surface, so that the handwritten input is displayed by the tablet. Pen- or stylus-based computing devices, such as tablet PCs, personal digital assistants (PDAs) and some smart phones, are some examples of electronic devices that can capture handwritten input. Other examples include the Reflex™ writing tablets available from Kent Displays Inc. of Kent, Ohio.

Some versions of electronic writing tablets may be configured for use simply as a “digital scratch pad.” The digital scratch pad type of electronic writing tablet allows handwritten input to be electronically captured, displayed and erased, but may not permit the handwritten input to be saved (e.g. in memory) or interpreted.

More advanced electronic writing tablets may include memory and a processor (e.g. a microprocessor) to permit storage and processing of the handwritten input. A coordinate system may be used to determine the locations at which pressure is applied to the electronic writing tablet at different points in time. Line drawing techniques may be used to create a computerized image of the digitally captured handwritten input. Computerized routines for handwriting or image recognition and analysis may be employed to determine alphanumeric text corresponding to the handwritten input, or to prepare an image of the handwritten input for display or for transmission to a remote device. Such routines may employ, for example, optical character recognition (OCR), image recognition, intelligent character recognition (ICR), and/or intelligent word recognition (IWR) techniques, to name a few. A number of software products that are directed to handwriting recognition and analysis are commercially available.

### SUMMARY

The present invention comprises one or more of the features recited in the appended claims and/or the following features which, alone or in any combination, may comprise patentable subject matter.

According to one aspect of this disclosure, a patient support system includes a patient support that has a plurality of features. The patient support system also includes a control system that electronically controls one or more of the features of the patient support, and an electronic writing tablet operably coupled to the control system. The electronic writing tablet includes a surface configured to receive handwritten input in an electronic form, where the control system is configured to process the handwritten input received by the electronic writing tablet.

The control system may control an electronically controllable feature of the patient support in response to the handwritten input. The control system may store the handwritten input in memory. The control system may send the handwritten input to a remote system. The control system may associate the handwritten input with an input type, where the input type is one of data, communication, and command. The control system may display the handwritten input on a siderail, headboard, footboard, and/or pendant device.

The patient support may be a headwall, footwall, table, support arm, column, chair, or other type of patient support, where the electronic writing tablet is mounted to the patient support. The patient support may include a touchscreen graphical user interface, where the electronic writing tablet is positioned adjacent the touchscreen graphical user interface.

According to another aspect of this disclosure, a patient support includes a base, a frame supported by the base, and a deck supported by the frame and configured to support a person in a plurality of positions including a horizontal position, where the deck has a plurality of articulating deck sections. The patient support also includes a user interface coupled to the frame, where the user interface includes an electronic writing tablet. The electronic writing tablet has a surface that receives and displays handwritten input from a person situated on the patient support and/or a person not situated on the patient support. The patient support also includes a control system that controls one or more features of the patient support and processes the handwritten input received by the electronic writing tablet.

The user interface may include selectable controls each corresponding to a different type of handwritten input. The selectable controls may be positioned adjacent the electronic writing tablet. The control system may associate the handwritten input with an input type and may process the handwritten input according to the input type.

The user interface may include an overlay that is supported by the surface of the electronic writing tablet. The overlay may include a graphical depiction of at least a portion of a patient support. The control system may process handwritten input displayed on the surface adjacent the graphical depiction of the patient support as a request to adjust a position of an articulating deck section of the patient support. The control system may initiate the requested adjustment of the articulating deck section in response to the handwritten input. The control system may associate the handwritten input with a corresponding data value and store the corresponding data value in memory. The control system may send the data value to an electronic medical records system.

According to a further aspect of this disclosure, a control system for a bed is configured to control an electronically-controllable feature of the bed, receive handwritten input from an electronic writing tablet coupled to the bed, determine an input type of the handwritten input, and process the handwritten input according to the input type.

The control system may initiate the electronically-controllable feature of the bed if the input type indicates that the handwritten input is a command relating to the electronically-controllable feature of the bed. The control system may associate the handwritten input with a corresponding data value if the input type indicates that the handwritten input is information. The control system may receive handwritten input from multiple electronic writing tablets coupled to the bed.

### BRIEF DESCRIPTION OF THE DRAWINGS

The detailed description particularly refers to the following figures, in which:

FIG. 1 is a perspective view of a patient support system including a bed, a headwall, and a patient pendant device connected to the bed, with electronic writing tablets incorporated therein;

FIG. 2 is a partial front elevation of the headwall of FIG. 1, showing an electronic writing tablet mounted to the headwall and an electronic medical records system user interface adjacent thereto;

FIG. 3 is a partial perspective view of a hospital bed, a caregiver user interface mounted thereto, and an electronic writing tablet integrated with the caregiver user interface;

FIG. 4 is a display screen for a caregiver user interface, including an electronic writing tablet option;

FIG. 5 is another display screen for a caregiver user interface, which may be displayed when the electronic writing tablet option of FIG. 4 is selected, showing a portion of the screen configured as an electronic writing tablet, with electronic handwritten input displayed thereon;

FIG. 6 is a partial perspective view of an overbed table including an electronic handwriting tablet, with electronic handwritten input displayed thereon;

FIG. 7 is a partial perspective view of an overbed table including another electronic handwriting tablet, which has a bed graphic overlay, showing electronic handwritten input in relation to the bed graphic;

FIG. 8 is a perspective view of a handheld pendant device being used by a patient, where the device includes an electronic writing tablet;

FIG. 9 is a display screen for the pendant device of FIG. 8, showing handwritten input thereon;

FIG. 10 is a block diagram of a patient support system including at least one electronic writing tablet, where the patient support system is connected to remote systems via a communication network;

FIG. 11 is a flow diagram illustrating electronic handwriting input processing routines that may be executed by the bed control unit of FIG. 10; and

FIG. 12 is a top perspective view of a chair with an integrated electronic writing tablet and patient controls.

### DETAILED DESCRIPTION

While the concepts of the present disclosure are susceptible to various modifications and alternative forms, specific exemplary embodiments thereof are shown by way of example in the drawings and are described in detail herein. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

A patient care environment, such as a hospital, clinic, surgery center, acute care center, long term care center, or home, for example, includes a patient support system 2. As illustrated, the patient support system 2 includes a headwall 4, which is mounted to a wall or other vertical structure 3 in a room of a hospital or other health care facility, and a bed 10, which is also located in the room.

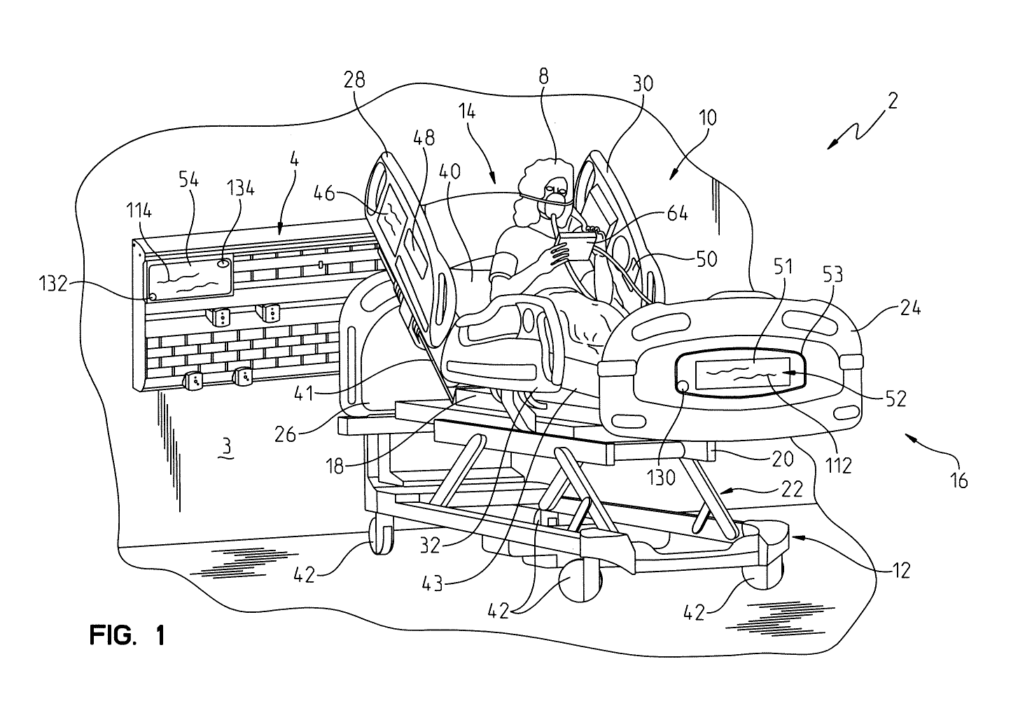

The headwall 4 and the bed 10 each include at least one electronic writing tablet 52, 54 mounted thereto or integrated therewith. Other patient care environments may include other patient support devices alternatively or in addition to those shown in FIG. 1, such as a stretcher, surgical table, footwall, support arm, support column, footboard shelf, headboard shelf, care cart, lift, or piece of furniture (such as a desk, chair, table, couch or shelving), to name a few, any of which may have an electronic writing tablet incorporated therein, in accordance with this disclosure.

The bed 10 is designed to support a person in a seated position, a laying-down position, and a variety of positions in between those two positions. The bed 10 is of a type that is typically used in hospitals and other facilities in which health care is provided, and has a number of features that are controlled electronically by an on-board bed control unit (BCU) 70. However, this disclosure applies to any type of bed or similar structure, including but not limited to stretchers, tables, chairs, and other patient support structures, whether or not all of the features of the illustrated bed 10 are included in such structure, and whether or not such patient support structure includes other features not mentioned herein.

The bed 10 has a head end 14 and a foot end 16 longitudinally spaced from the head end 14. While the bed 10 often assumes a flat or horizontal position, FIG. 1 shows the bed 10 with the head end 14 elevated relative to the foot end 16, and a patient 8 positioned on the bed 10. In some cases, the patient 8 may have a medical condition that affects his or her ability to communicate orally. For example, as shown in FIG. 1, the patient 8 may need to use a breathing apparatus, such as a tracheal tube or a ventilator 6, for breathing assistance. Certain neurological disorders, medical disabilities or other conditions may limit the patient's ability to speak, or to speak and be understood by a caregiver or other staff person. Even relatively healthy patients may have difficulty communicating orally or verbally, due to language barriers or during periods in which they are asleep or unconscious.

Many structural aspects of the bed 10 are similar to those of conventional hospital beds, but are described briefly herein for completeness. As illustrated, the bed 10 includes a base 12, which is movably supported by a number of wheels or casters 42. A frame 20 is coupled to and supported by the base 12. A lift mechanism 22 is coupled to the base 12 and to the frame 20. The lift mechanism operates to raise, lower, and tilt the frame 20 relative to the base 12.

A deck 18 is coupled to and supported by the frame 20. The deck 18 supports a mattress 40, which, in turn, may support a person positioned thereon. The deck 18 has a number of rotatable sections including, in the illustrated embodiment, an articulating head section 41 and an articulating foot section 43, which, as noted above, allow the bed 10 to assume a variety of positions including a horizontal position, a chair position, and a number of positions intermediate the horizontal and chair positions.

The bed 10 has a number of siderails, namely opposing head end siderails 28, 30 and opposing foot end siderails 30, 32. The bed 10 also has a foot endboard 24 and a head endboard 26, each of which may be removably coupled to the frame 20 or to a section of the deck 18.

As noted above, the bed 10 has one or more electronically-controllable bed functions or features, which are operated and controlled by the BCU 70. Such features may include adjusting the position, height, length, or width of the bed, raising, lowering, or pivoting a section of the bed, weighing a person positioned on the bed, inflating, deflating, or adjusting inflation in one or more sections of the mattress 40, laterally rotating a person positioned on the bed, monitoring the position of a person on the bed, and/or other automated functions or features. Some examples of hospital beds that have electronically-controlled functions and features are disclosed in U.S. Pat. Nos. 5,715,548; 6,185,767; 6,336,235; 6,694,549; 7,454,805; 6,708,358; 7,325,265; 7,458,119; 7,523,515; 7,610,637; 7,610,638; and 7,784,128.

The electronically-controllable features and functions of the bed 10 may be activated, configured, and deactivated by user inputs that are translated into electrical signals and forwarded to the BCU 70 by input devices or input-output devices, which include, in the illustrated embodiment, one or more patient (e.g. 60, 62, 64, 66, 264), one or more caregiver electronic writing tablets (e.g. 46, 52, 54, 58, 68), one or more non-tablet patient controls (e.g. 50, 266) and one or more non-tablet caregiver controls 48. In the illustrated embodiment, the control 46 is a graphical touchscreen user interface that has electronic writing tablet features incorporated therewith, as described below. The non-tablet controls 48, 50 are hardpanel controls (e.g. membrane switches, buttons, dials, levers, slides or the like) that issue electrical output signals in response to the application of force or pressure thereon or physical displacement of a mechanical device.

The controls 46, 48, 50 are, and the controls 52, 54, 58, 60, 62, 64, 66 may (depending upon the features of the electronic writing tablet used) coupled to circuitry that conveys voltage output signals to the BCU 70 in response to the application of force or pressure thereon. While the controls (e.g. 46, 48, 50, 52, 54, 58, 60, 62, 64, 66, 68) are shown as being mounted to particular components of the patient support system 2, this disclosure contemplates that each of them may be placed in any suitable location that is accessible to a caregiver, patient, or other anticipated user, as the case may be.

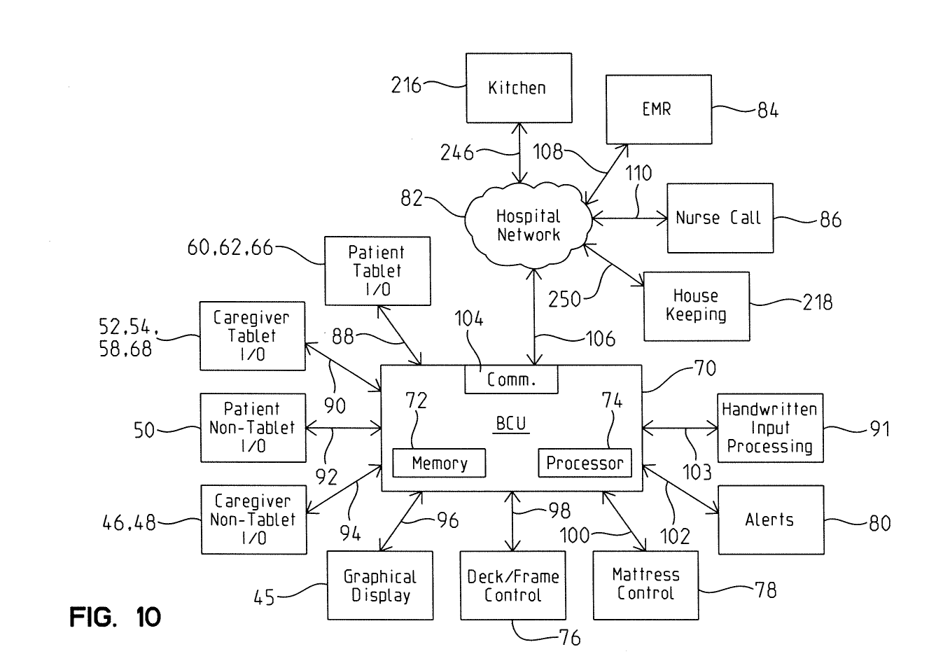

Referring to FIG. 10, the BCU 70 includes one or more processors 74 (e.g. microprocessors or microcontrollers), memory 72, and electrical and/or computer circuitry mounted on one or more substrates (e.g. printed circuit boards), which are typically located in a housing that is maintained in any suitable location on the bed or elsewhere as may be required for a particular design or implementation. The physical location of the BCU 70 relative to the bed 10 is not important for the purposes of the present disclosure.

In many instances, the BCU 70 receives electrical input from a number bed function modules or devices, which, in addition to the controls (e.g. 46, 48, 50, 52, 54, 58, 60, 62, 64, 66, 68), may include a graphical display module 45, a deck/frame control module 76, a mattress control module 78, an alerts module 80, and a handwritten input processing module 91, among others.

The graphical display module 45 controls the display of graphics, selectable icons, data and information by the touchscreen user interface 46. In the illustrated embodiment, the graphical display module 45 is configured to, among other things, execute upon request computer routines or processes that generate a display of historical data relating to the patient using the bed 10 or the bed 10 itself. Such historical data may include a history of the patient's weight (or other physiological data) over time, or a history of the bed's position (e.g. chair, flat, or other), head angle settings, or mattress pressure settings over time.

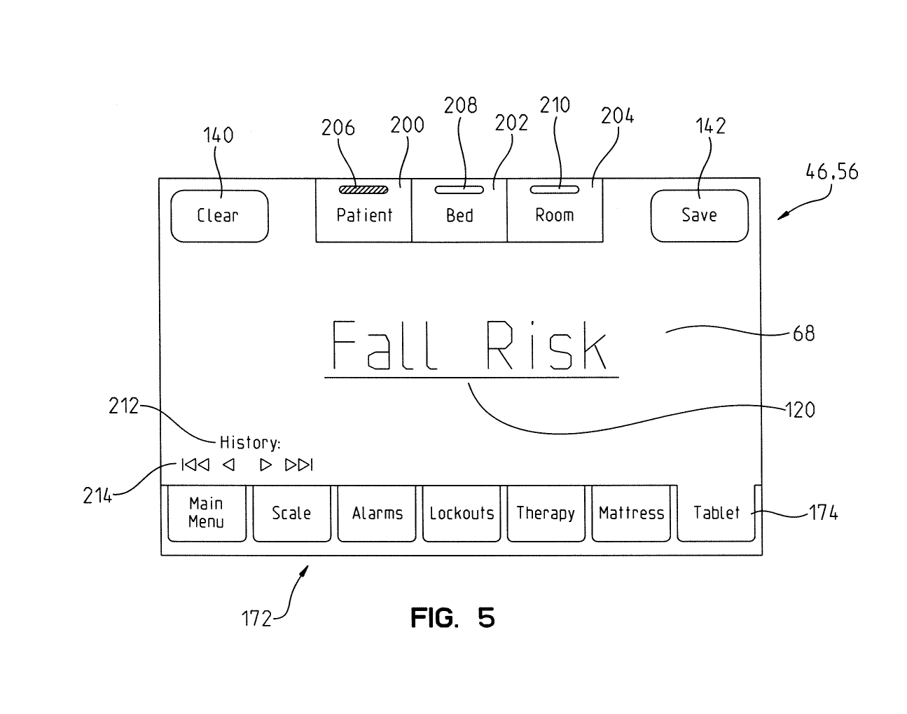

As illustrated in FIG. 5, one embodiment of the graphical display module 45 maintains a history 212 of handwritten input received by the electronic writing tablet 68, described below. In this embodiment, the graphical display module 45 saves individual instances of handwritten input (e.g. handwriting 120) that are captured by the electronic writing tablet 68, as images (e.g. .jpg, .bmp, or other type of image file) that can be viewed by a caregiver on the touchscreen graphical user interface 46. In the illustrated example, the handwriting images are viewable one at a time using forward and backward scrolling arrows 214. However, this disclosure also contemplates displaying a list or table of icons, titles or other identifiers corresponding to the handwriting images, from which the caregiver may select a particular image from the list to be viewed, as well as other suitable display techniques.

Returning to FIG. 10, the deck/frame control module 76 includes electrical circuitry, computer routines and/or processes that control the movement of the rotatable sections of the deck 18 and the movement of the frame 20. While not visible in the view of FIG. 1, the bed 10 has a number of powered actuators, such as electric linear actuators or hydraulic cylinders, which enable the bed to assume different positions. One or more actuators are coupled to the frame 20 to enable raising, lowering, and tilting of the frame 20 relative to the base 12. Other actuators are coupled to the deck 18 to enable pivoting of the rotatable deck sections relative to the frame 20.

In general, each of the actuators is coupled to a power plant (e.g. a motor) and has an extending/retracting arm or linkage. One end of the arm or linkage is coupled to the power plant and the other end is coupled to the frame 20 or the relevant deck section (e.g. 41, 43). The power plant drives the arm or linkage in one direction to provide movement of the frame 20 or deck section in one direction (e.g. raising or pivoting upwardly), and drives the arm or linkage in the opposite direction to provide movement of the frame 20 or deck section in the other direction (e.g. lowering or pivoting downwardly). The power plant is responsive to control signals issued by the BCU 70.

The deck/frame control module 76 accepts inputs from various user interfaces and controls (e.g. the caregiver and patient input-output devices 46, 48, 50), to control bed movement, adjustment, and articulations, to, for example, change the position or orientation of the deck or frame, adjust the length of the bed, and/or adjust the width of the bed. The deck/frame control module 76 executes computer logic to determine, based on inputs from sensors coupled to the bed's actuators, the actual position of the bed deck sections. The bed deck/frame control module 76 determines whether the position of any of the deck sections is to be adjusted, based on various inputs, and issues control signals to the bed actuators to initiate movement, adjustment, or articulation as needed.

In accordance with this disclosure, bed deck or frame control functions and features of the bed 10 may be initiated by one or more of the controls (e.g. 46, 48, 50, 52, 54, 58, 60, 62, 64, 66, 68, 264, 266). Further, the determination of whether or to what degree or extent to articulate or move the bed or parts thereof may be based on information that is available to the bed deck/frame control module 76 as a result of inputs received by one or more of the electronic writing tablets (e.g. 46, 48, 50, 52, 54, 58, 60, 62, 64, 66, 68, 264).

The mattress control module 78 controls the operation of the mattress 40, if the mattress 40 includes air features (e.g. low air loss) and/or air bladders, where the supply of air thereto is automated or automatically adjusted based on changes in parameters. The mattress control module 78 includes computer routines or processes that execute logic to control the inflation and deflation of the mattress 40, as well as any therapy features of the mattress 40 (which may include lateral rotation, turning assistance, percussion, vibration, and/or low-airloss therapies, to name a few). The mattress control module 78 accepts input from the caregiver input-output module 46, 48 relating to desired bladder pressure and/or mattress therapies (e.g. percussion, vibration, rotation). The mattress control module 78 processes inputs received from the caregiver input-output module 46, 48 and/or other modules (e.g. the bed weighing system) and sends control signals to the mattress or a mattress air control unit (not shown) to control or adjust the supply of air to different parts of the mattress as needed.

In accordance with this disclosure, mattress control functions and features may be initiated by one or more of the controls (e.g. 46, 48, 50, 52, 54, 58, 60, 62, 64, 66, 68). Further, the determination of whether to initiate a particular mattress therapy, adjust the pressure in one or more sections of the mattress 40, or supply or remove air from a portion of the mattress, may be based on information that is available to the mattress control module 78 as a result of inputs received by one or more of the electronic writing tablets (e.g. 52, 54, 58, 60, 62, 66, 264).

The alerts module 80 includes computer routines or processes that control the monitoring of the patient's position on the bed 10 and the activation of alerts or alarms in response to detection of a monitored position. Monitored positions may include the presence or absence of the patient on the patient support, the patient being near a side edge or end of the patient support, and/or the patient moving to a seated position on the patient support. The alerts module 80 detects the angles and/or positions of the frame 20 and all the appropriate deck sections, relative to each other or to the horizontal. To do so, it interfaces with various sensors. The alerts module 80 executes computer logic to determine, based on input from the sensors and parameters relating to acceptable bed positions or angles as determined according to the requirements of a particular design, implementation, or use of the bed 10, whether to generate an alert (e.g. an electronic, audio or visual indication relating to the status of the patient support).

In accordance with this disclosure, alerting functions and features of the bed 10 may be initiated by one or more of the controls (e.g. 46, 48, 50, 52, 54, 58, 60, 62, 64, 66, 68). Further, the determination of whether to generate an alert may be based on information that is available to the alerts module 80 as a result of inputs received by the one or more of the electronic writing tablets 48, 50, 52, 54, 58. The alerts module 80 may output status and/or alert information to BCU 70 and/or the network 82 for use by one or more remote systems or devices, such as a nurse call system 86, an electronic medical records system 84, a housekeeping or workflow communication system 218 and/or a kitchen order management system 216.

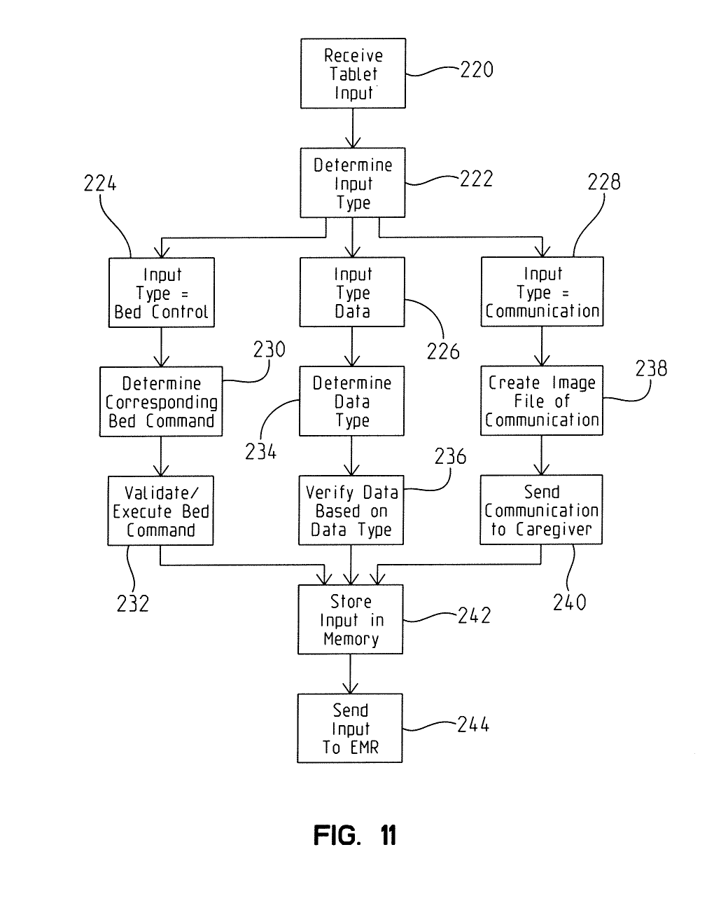

The handwritten input processing module 91 includes computer routines or processes that execute logic to process handwritten input captured by one or more of the electronic writing tablets 52, 54, 58, 60, 62, 66. Examples of such processes are illustrated in FIG. 11, described below.

The BCU 70, the controls (e.g. 46, 48, 50, 52, 54, 58, 60, 62, 64, 66, 68, 264, 266), the graphical display module 46, the deck/frame control module 76, the mattress control module 78, the alerts module 80, and the handwritten input processing module 91 communicate electronically via a number of signal paths (e.g. 88, 90, 92, 94, 96, 98, 100, 102, 103, 106, 108, 110, 246, 250) and are arranged according to a suitable system architecture to allow unidirectional and/or bidirectional exchange of data and instructions among these and other components as required to execute a given feature or function of the bed 10.

The BCU 70 may be connected to the electronic medical records system 84, the patient-nurse communication (“nurse call”) system 86, the kitchen order management system 216, the housekeeping or workflow system 218, and/or other remote computing devices and systems, via a communications interface 104, which is coupled to the hospital network 82. The network 82 may be an Ethernet network or other suitable electronic communications network, and may be configured according to a TCP/IP or other suitable electronic communications protocol. Moreover, the BCU 70 may communicate with systems mounted to the headwall 4 via the network 82 directly via a bed interface unit (BIU), which is typically mounted to the wall 3 or the headwall 4 adjacent a bed location.

In general, each of the representative signal paths (e.g. 88, 90, 92, 94, 96, 98, 100, 102, 103, 106, 108, 110, 246, 250) may include wired or wireless connections and may include one or more signal paths therein as may be needed to accomplish the sending and receiving of data and/or instructions between or among the various modules and systems of the bed 10 and external devices or systems (e.g. 84, 86, 216, 218).

Among other things, the BCU 70 processes inputs from the various electronically controlled components and modules of the bed 10 and external systems 84, 86, 216, 218, stores data in and retrieves data from memory, and executes computer logic to control the operation of the electronically-controllable features of the bed 10. It is contemplated that the logic, functions and processes identified herein as being part of the BCU 70 may be implemented as one or more distributed modules that are in communication with the BCU 70. Also, this disclosure contemplates that the functions or features of any one or more of the modules may be incorporated into or performed by the BCU 70 or any of the other modules. Further, the BCU 70 and/or any one or more of the modules may comprise a number of different units or sub-modules rather than being contained in a single housing. For example, handwritten input processing routines (e.g. 220, 222, 224, 226, 228, 230, 232, 234, 236, 238, 240, 242, 244) may be designed as separate modules or processes and/or may be distributed across multiple storage and/or computing devices connected by a network.

In the embodiment of FIG. 1, the foot endboard or footboard 24 includes an electronic writing tablet 52. One side of the footboard 24 faces the patient, and the other side faces outwardly away from the patient. As shown in FIG. 1, the outwardly facing side of the footboard 24 is configured to support the electronic writing tablet 52. The electronic writing tablet 52 may be positioned in a recessed area of the footboard 24 and secured to the footboard 24 by a surrounding frame 53, which is bolted, adhered, or otherwise fixedly or removably coupled to the footboard 24 as may be required for a particular design.

The electronic writing tablet 52 is of the LCD, digital scratch pad type, in that it captures and displays, but does not save, handwriting (e.g. 112). However, it, as well as the other electronic writing tablets described herein, may be an LCD type display or may be comprised of a VGA touchscreen system that is configured with the requisite level of sensitivity and resolution needed to capture and display handwritten input.

The writing surface 51 of the electronic writing tablet 52 is configured to respond to the application of pressure by a human finger or fingernail. Thus, use of the electronic writing tablet 52 does not require a pen, pencil, marker, or other writing implement. A control 130 is touchable to erase the handwriting displayed by the electronic writing tablet 52. For handwritten communications, the electronic writing tablet 52 may be preferable to traditional whiteboards or dry-erase boards, which require maintaining a supply of suitable writing implements (such as dry-erase markers) and erasers, and may be more difficult to clean or keep clean.

In the illustration of FIG. 1, a caregiver has communicated a message pertaining to the condition of the patient 8 to others who enter the patient's room, using the electronic writing tablet 52. Using the electronic writing tablet 52, the caregiver does not need to take the time to press a multitude of buttons or navigate what may be a complicated or cumbersome menu structure of a more conventional non-tablet user interface.

For security, validation, or other reasons, the electronic writing tablet 52 may be configured to require entry (e.g. writing on the surface 51) of a fingerprint, or a password, personal identification number (PIN), or other personal identifier, prior to accepting the handwritten input, in order to verify that the person writing on the electronic writing tablet 52 is authorized to do so. In such implementations, the electronic writing tablet 52 may comprise a processor and executable routines for validation of the handwriting input, or the electronic writing tablet 52 may be configured to communicate with the BCU 70 such that the security/validation routine is performed by the BCU 70.

The electronic writing tablet 54 is similar to the electronic writing tablet 52, except that it is mounted to the headwall 4. As illustrated in FIG. 1, the electronic writing tablet 54 is simply a digital scratch pad type of communication device that may have any or all of the features described above with reference to the electronic writing tablet 52. However, the electronic writing tablet 54 has two controls: a save control 134 and an erase control 132. Using the electronic writing tablet 54, the handwriting input 114 may be saved to an image file by touching the save control 134, or may be erased by touching the erase control 132.

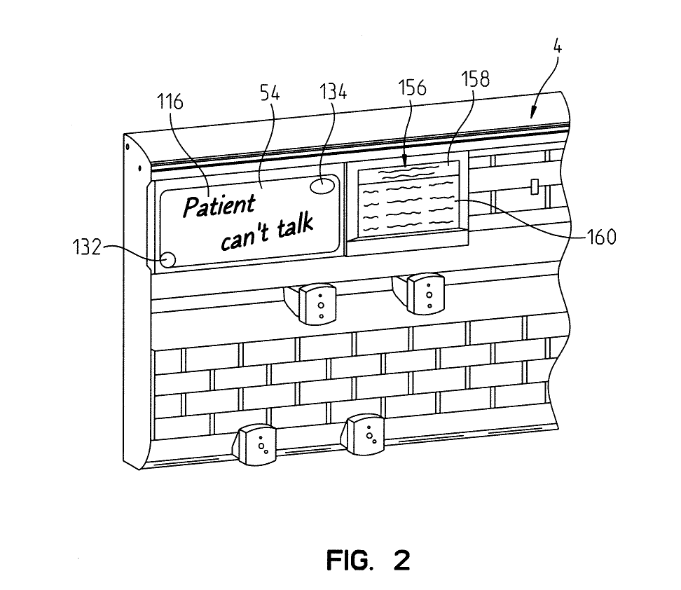

In FIG. 2, the electronic writing tablet 54 is shown mounted adjacent a user interface 156 of the EMR system 84. The user interface 156 displays patient data relating to the patient 8, such as the patient's name and patient I.D. number, in an area 158. The patient data may be obtained by accessing a data structure associated with the EMR system 84. Also, the user interface 156 displays a list 160 of handwritten input entries that have been saved to the EMR system 84 (e.g. by pressing the save button 132 on the electronic writing tablet 54).

The handwritten input saved at the electronic writing tablet 54 may be communicated to the EMR system 84 via the BCU 70 and the network 82, as shown in FIG. 10, or the electronic writing tablet 54 may be coupled directly to the EMR system 84 using an appropriate configuration of signal paths as described above. For example, the electronic writing tablet 54 may include a network interface similar to the interface 104, so that a signal path 90 may be coupled directly to the network 82 rather than to the BCU 70.

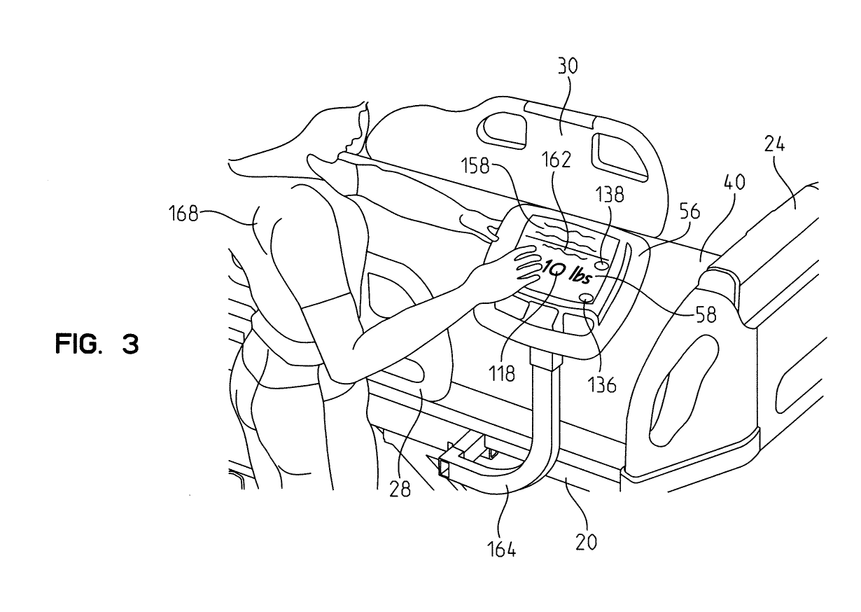

Another version of a caregiver-oriented electronic writing tablet 58 is shown in FIG. 3. The electronic writing tablet 58 is integrated with a bed-mounted caregiver user interface 56, which also displays data 158 from the EMR system 84 using the communication links described above and shown schematically in FIG. 10. As illustrated, the caregiver user interface 56 is coupled to the frame 20 by a support 164. In other embodiments (such as user interface 46 shown in FIG. 1), the user interface 56 may be incorporated into or supported by a siderail, footboard, or other suitable support structure.

The electronic writing tablet 58 is similar to the electronic writing tablets 52, 54 and may have any or all of the features described above with reference to the electronic writing tablets 52, 54. In addition, the electronic writing tablet 58 is configured to accept and validate handwritten input that corresponds to alphabetical, numerical, alphanumeric, graphical or symbolic data, which may correspond to words or phrases in any language (including languages that use alphabets or symbols other than the Roman alphabet letters). In the example of FIG. 3, the caregiver 168 has handwritten the patient's weight 118 on the electronic writing tablet 58, using a finger or fingernail.

The caregiver 168 initiates computerized processing (e.g. by the electronic writing tablet 58 or the BCU 70 or the EMR system 84) of the handwritten input 118 by pressing a send button 138. The processing may include classifying the handwritten input 118 according to a language type (e.g. “English”), and/or an input type (e.g. “data”), and verifying the information represented by the handwritten input 118. If the handwritten input 118 cannot be verified by the computerized recognition or analysis routines, or if the caregiver 168 has written the information incorrectly to begin with, the caregiver 168 may press a clear button 136. In view of the handwriting processing software products that are currently commercially available, it will be understood that there are a number of electronic handwriting recognition and analysis routines that may be used to recognize and/or analyze the handwritten input 118.

Once the handwritten input 118 has been verified (in the illustration, it corresponds to a numerical value 162 indicating the patient's weight, as may be determined by the “lbs” written following the numerical value), the caregiver 168 may press a send button 138 to have the numerical data stored in the EMR system 84. In this way, alphabetical, numerical, or alphanumeric data can be captured and saved to EMR records without the need for a keyboard or numeric keypad. Accuracy of the data entry may be increased since the risk of the caregiver pressing an incorrect key is eliminated by the use of the electronic writing tablet 58.

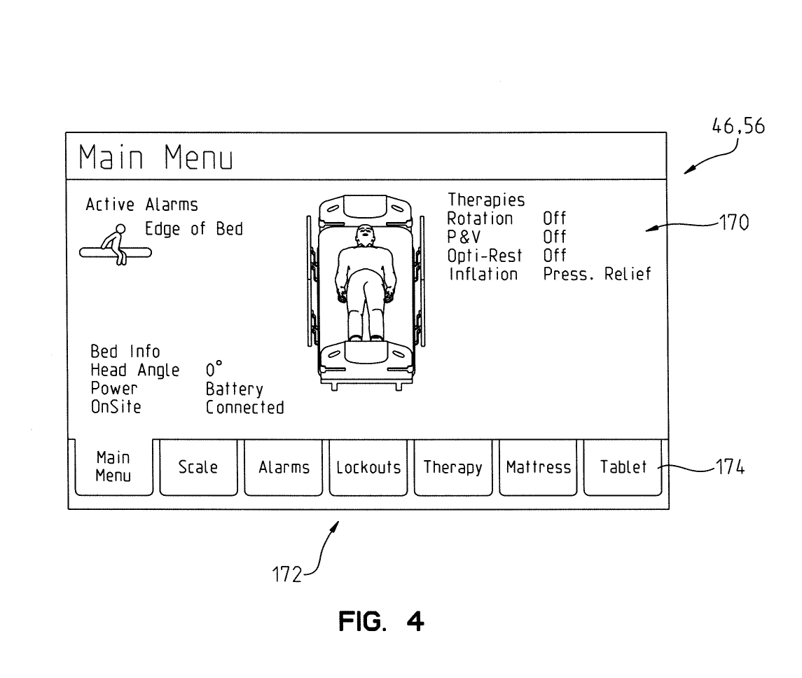

Alternatively or in addition to the user interface 58, the caregiver user interface 46, 56 may include an electronic writing tablet feature within a more traditional (e.g. menu-driven) caregiver user interface design, as shown in FIGS. 4-5. In the embodiment of FIGS. 4-5, an electronic writing tablet 68 is accessible from a main menu screen 170 by pressing a “Tablet” tab 174. The other tabs (e.g. “Scale,” “Alarms,” “Lockouts,” “Therapy,” and “Mattress,” relate to electronically-controllable functions and features of the bed 10 as described above.

The electronic writing tablet 68 may have any or all of the features described above with reference to the electronic writing tablets 52, 54, 56, 58. As shown in FIG. 5, a number of selectable controls 140, 142, 200, 202, 204 are displayed adjacent the electronic writing tablet 68. The controls 140, 142, 200, 202, 204 may be of an LCD or VGA-touchscreen type. The controls 200, 202, 204 correspond to different types of handwritten input. In other words, the handwritten input (e.g. 120) is categorized by the caregiver according to its input type. In the illustrated example, the handwritten input 120 relates to the patient, so the caregiver has selected the “Patient” button 200. Selection of the Patient button is indicated by the indicator 206, which has changed state (e.g. color) relative to the other indicators 208, 210. The indicators 208, 210 correspond to input type buttons 202, 204, respectively, which have not been selected.

Examples of handwritten input having an input type of “Patient” include any information or comments relating to the patient or the patient's condition, such as whether they are mobile or immobile, alert or non-responsive, whether they need to be fed, bathed or changed, and whether they have pressure ulcers or other health-related conditions. Examples of handwritten input having an input type of “Bed” include any information or comments relating to the bed 10, such as the position or configuration of the bed or mattress, whether the bed or mattress needs service, and whether the linens need to be changed. Examples of handwritten input having an input type of “Room” include any information or comments relating to the patient's room, such as the room temperature, whether the room needs to be cleaned, and whether any items in the room need attention (e.g. a TV, clock or radio). The input types illustrated in FIG. 5 are intended to be illustrative and non-exhaustive. It will be understood that handwritten input may be categorized in any manner that may be useful to a particular use, environment or facility, and that any number of input type selectors 200, 202, 204 may be provided.

Here, and on any of the electronic writing tablets (e.g. 46, 48, 50, 52, 54, 58, 60, 62, 64, 66, 68, 264), any type of writing or drawing strokes may be used. Thus, a picture or symbol might be drawn on the electronic writing tablet when appropriate words are unknown or cannot be expressed, or when it may be more efficient or effective to communicate using pictures or symbols rather than numbers, letters or words.

Once the input type has been selected and the handwritten input 120 is displayed to the satisfaction of the caregiver, the caregiver may press the Save button 142 to store an image of the handwritten input 120 in memory (e.g. 72). The clear button 140 may be used to erase the handwritten input 120 from the display. FIG. 5 also illustrates the handwriting input history feature 212, 214, which is described above.

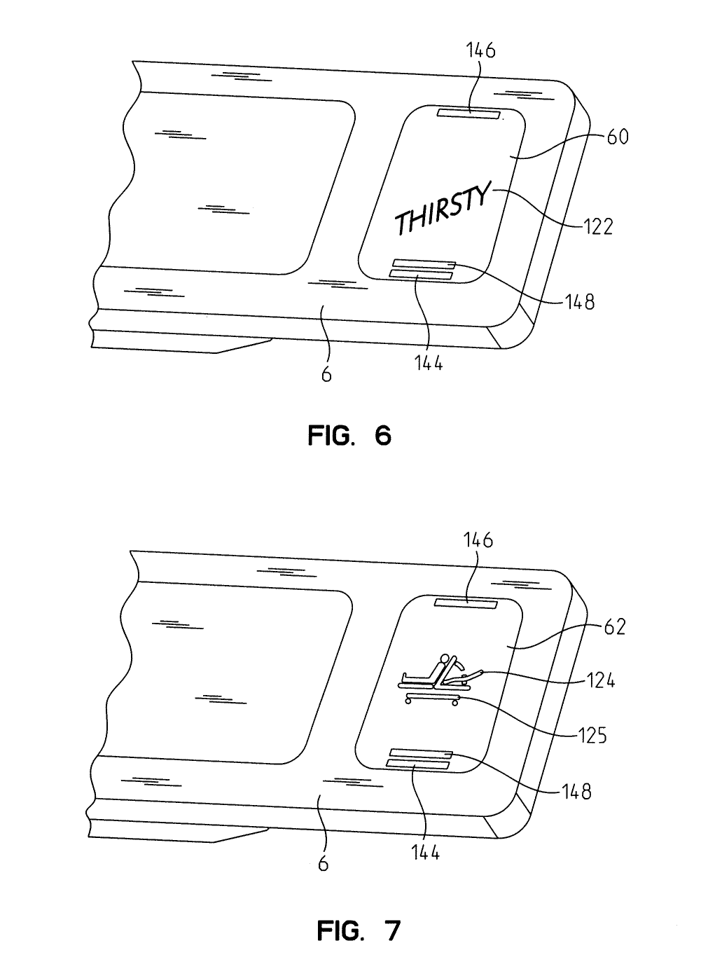

A number of patient-oriented electronic writing tablets 60, 62, 64, 66 are illustrated in FIGS. 6-9. In general, an overbed table 6 is a movable table that may be positioned so that the table surface extends transversely across and above the bed, for use by the patient 8. Typically, the patient 8 uses the overbed table 6 for eating or for supporting items such as books or magazines. With an electronic writing tablet incorporated therein, the overbed table 6 may additionally be used for communication between the patient 8 and a caregiver or other staff person, particularly when the patient 8 is unable to effectively communicate orally.

In FIG. 6, an overbed table 6 including an electronic writing tablet 60 is illustrated. The electronic writing tablet 60 is positioned in a recess defined in the overbed table 60. The electronic writing tablet 60 is similar to the electronic writing tablet 52, and may include one or more of the features described above. As in the above-described examples, a person's finger or fingernail may be used to create the handwritten input. The handwritten input 122 may be cleared by pressing an erase button 144. An image of the handwritten input 122 may be saved in memory (e.g. memory 72) by pressing the Accept button 148.

The electronic writing tablet 60 may be used for bidirectional communication between the patient 8 and a caregiver or other person. For example, a caregiver may opt to use the electronic writing tablet 60 to communicate with the patient 8 in the event the patient 8 is hard of hearing, if there is a language barrier, or even if the patient is sharing a room with another person who is sleeping. Alternatively or in addition, a caregiver or other person may use the electronic writing tablet 60 for therapy purposes (e.g. for drawing games or brain-teasers such as stickman or tic-tac-toe), or for amusement (e.g. for drawing animals or funny faces, in the case of a child/pediatric patient). Thus, a second erase button 146 is provided near a side of the electronic writing tablet 60 that may be nearer to a person who is communicating with the patient using the electronic writing tablet 60.

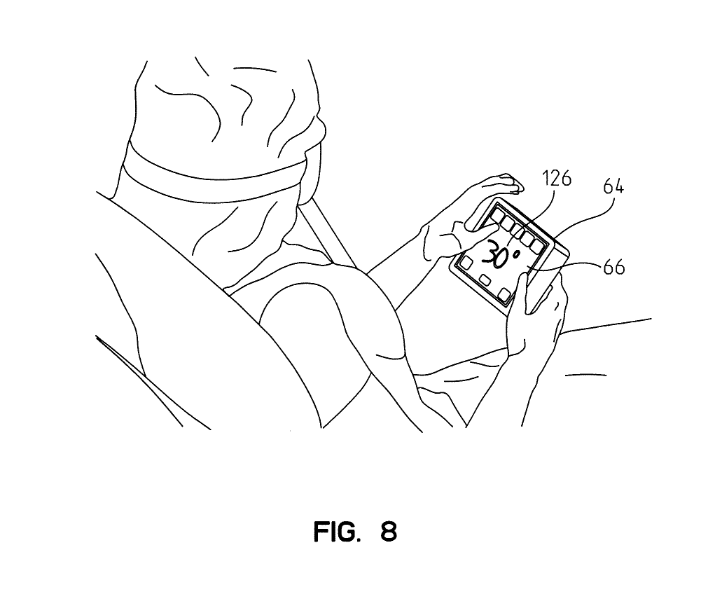

Another version of the overbed table 6 is shown in FIG. 7. In FIG. 7, the overbed table includes an electronic writing tablet 62 that is similar to the electronic writing tablet 60 and may include one or more of the features described above. The electronic writing tablet 62 is in electrical communication with the BCU 70 via a signal path or paths 88, which may include wiring routed through the table 6 and connected to an electrical port located on the bed 10.

The electronic writing tablet 62 includes a graphical overlay 125, which is designed to facilitate the use of handwritten input to control the bed 10. In the illustrated embodiment, the overlay 125 is in the shape of a hospital bed, and is designed to encourage the patient to draw the angle at which the patient would like the head section of the bed to be elevated. A coordinate system associated with the overlay 125 is used to determine the angle of the line 124 drawn by the patient, relative to the boundaries defined by the overlay 125. Thus, the handwritten input 124 is drawn to indicate the desired head of bed angle relative to the horizontal. In other embodiments, the graphical overlay 125 may be designed to facilitate handwritten input of other types of bed commands (such as the desired length or angle of the foot section, or the desired width or firmness of the mattress).

For example, some versions of the bed 10 may include an “auto-contour” feature such as a “chair” button. A chair button moves the bed 10 into the chair position with a single button press (i.e. rather than a first button press to raise the head section, a second button press to lower the foot section, etc.). However, with the chair button, the chair position is predefined. The electronic writing tablet 62 allows the patient to draw with particularity the desired position of the bed, which may or may not correspond to a pre-defined bed position. Also, the electronic writing tablet 62 eliminates the need to press multiple buttons (e.g. head up, thigh up, foot down) multiple times to achieve the desired bed position.

The Erase buttons 144, 146 can be used by the patient or other person to clear the handwritten input from the electronic writing tablet 62. If the handwritten input is satisfactory, the Accept button 148 may be pressed. Once the Accept button 148 is pressed, the BCU 70 executes the handwritten input processing routines 91 to determine the bed command corresponding to the desired bed configuration represented by the handwritten input. The BCU 70 then sends any necessary control signals to the appropriate actuators or other bed components to execute the bed command.

Referring to FIGS. 1 and 8-9, the bed 10 may be equipped with a patient pendant control device 64, which is a handheld device for controlling features of the bed or within the patient's room (e.g. TV or radio) at the point of care. The pendant device 64 includes an electronic writing tablet 66, either alternatively or in addition to more traditional (e.g. hardpanel or GUI-touchscreen) controls. The electronic writing tablet 66 may include one or more of the features described above.

Similarly to the electronic writing tablet 68, the electronic writing tablet 66 has a number of input type selectors 180, 182, 184, 186, 188 positioned adjacent thereto. The input type selectors 180, 182, 184, 186, 188 may be of an LCD or VGA-touchscreen type, for example. The input type selectors 180, 182, 184, 186, 188 correspond to different types of handwritten input. In other words, the handwritten input (e.g. 126) is categorized by the patient according to its input type.

In the illustrated example, the handwritten input 126 relates to the desired angle of the bed, so the patient has selected the “Move” button 182. Selection of the Move button is indicated by the indicator 192, which has changed state (e.g. color) relative to the other indicators 190, 194, 196, 198. The indicators 190, 194, 196, 198 correspond to input type buttons 180, 184, 186, 188, respectively, which have not been selected.

Examples of handwritten input having an input type of “Hot/Cold” include any information or comments relating to the patient's temperature, such as whether they need a blanket, need air conditioning turned up, etc. Examples of handwritten input having an input type of “Move” include any information or comments relating to the position of the bed 10, such as the head angle, foot angle, thigh angle, bed height, or bed width. Examples of handwritten input having an input type of “Hard/Soft” include any information or comments relating to the mattress, such the firmness, softness, temperature, wetness, or a therapy feature (e.g. rotation, percussion, vibration). Examples of handwritten input having an input type of “Food” include food orders and any information or comments relating to food ordered or received, such as whether the food received is correct according to the food order. Examples of handwritten input having an input type of “Nurse” include requests for a nurse to come to the room, messages for the nurse, and any information or comments relating to communications with a nurse.

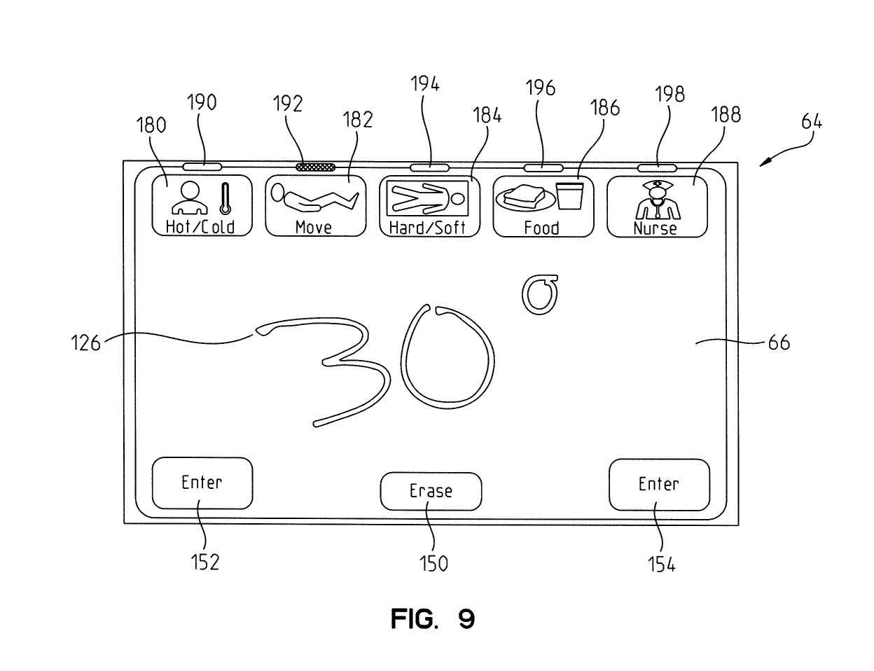

The input types illustrated in FIG. 9 are intended to be illustrative and non-exhaustive. It will be understood that handwritten input may be categorized in any manner that may be useful to a particular environment or facility, and that any number of input type selectors 180, 182, 184, 186, 188 may be provided.

Once the input type has been selected and the handwritten input 126 is displayed to the satisfaction of the patient, the patient may press the Enter button 152, 154. As illustrated, two Enter buttons are provided, to accommodate left- and right-handed patients, however this is not required. If an Enter button 152, 154 is pressed, an image of the handwritten input 126 is stored in memory (e.g. 72). The Erase button 150 may be used to erase the handwritten input 126.

The BCU 70 may process the handwritten input differently depending on the input type selected. For example, if the patient selects the Hot/Cold selector 180 or the Nurses selector 188, the BCU 70 may classify the handwritten input as a “communication” and send a communication to an appropriate caregiver or staff person informing them of the patient's handwritten message, via the nurse call system 86 or the housekeeping/workflow system 218. The handwritten message may be converted to a digital text message using handwriting recognition and/or analysis routines referred to above, or a copy of the image file containing the handwritten input 126 may be sent to the appropriate caregiver or staff person via the nurse call system 86 or other communication system used by the facility. Alternatively or additionally, the communication may be sent to a master station of the nurse call system 86 for display at the master station, at an electronic status board, and/or on a remote device (such as a nurse's mobile device). Such communication of the handwritten information may be accomplished using existing messaging and communication systems (including the Navicare® Nurse Call system, available from the Hill-Rom Company) or technology developed after the date of this disclosure.

If the patient selects the Move selector 182 or the Hard/Soft selector 184, the BCU 70 may classify the handwritten input as a “command” (i.e. a bed command or a mattress command, as the case may be) and process the handwritten input accordingly, in a similar fashion as is described above with reference to FIG. 7.

If the patient selects the Food selector 186, the BCU 70 may classify the handwritten input as an “order” and will process the handwritten input as a food order. The BCU 70 may use handwriting recognition and/or analysis routines to convert the handwritten input to a digital text message, or may simply forward an image file containing the handwritten input to the hospital's kitchen ordering system 216 via the network 82 as shown in FIG. 10.

FIG. 11 is a flow diagram illustrating computerized routines of the handwritten input processing module 91, which may be executed by the BCU 70. At routine 220, handwritten input is received by one of the electronic writing tablets (e.g. 46, 48, 50, 52, 54, 58, 60, 62, 64, 66, 68, 264), and forwarded to the BCU 70 where it may be stored, at least temporarily, in the memory 72. In embodiments where input type selectors are provided, or where handwriting analysis routines are provided, the routine 222 determines the input type corresponding to the handwritten input. Handwriting recognition and/or analysis software may be used to determine the input type in any language. The handwritten input processing module 91 may set a ‘default’ language or allow a user to select a preferred language for communication, in which case, the input type may be determined based on the default or selected language. For example, if handwriting recognition and/or analysis determines that “lbs” follows a numerical value, and the selected language is English, it may determine that the input relates to a patient's weight. Where input type selectors are provided, the routine 222 determines which input type selector has been selected and associates the input type with the handwritten data, accordingly.

The source of the handwritten input (i.e. whether the handwritten input originated at a caregiver-oriented input device or a patient-oriented input device) may also be taken into consideration. To accomplish this, each electronic writing tablet connected to the BCU 70 has a unique identifier that is attached to each communication from the electronic writing tablet to the BCU 70. A lookup table or other suitable data structure may be stored in memory 72, which maps the electronic writing tablet identifiers to their corresponding type as being either a patient- or a caregiver oriented device.

As will be apparent from the above-described illustrations, the input type may have two components (e.g. a type and sub-type). For example, if the input is received from a caregiver-oriented device (as indicated by the electronic writing tablet identifier), is associated with the “Patient” input selector, and contains the letters “lbs” following a numerical value, the input type may be assigned as (data, patient weight). If the input is received from a patient-oriented device (as indicated by the electronic writing tablet identifier), is associated with the “Move” input selector, and contains a numerical value followed by the degree symbol, the input type may be assigned as (bed control, head of bed angle).

The process advances to one of the routines 224, 226, 228, depending on the input type associated with the handwritten input. If the handwritten input is determined to be a request to control a function or feature of the bed 10, the routines 224, 230, 232 are invoked. If the handwritten input is determined to be data, the routines 226, 234, 236 are invoked. If the handwritten input is determined to be a communication (e.g. from the patient to a caregiver), the routines 228, 238, 240 are invoked.

For handwritten requests to control a feature or function of the bed 10, the routine 230 uses processes such as those described above to determine the particular bed command that corresponds to the handwritten input. The routine 232 checks to make sure the requested command is a valid command. For example, if the command is received from a patient-oriented input device, the routine 232 verifies that a patient is permitted to request the bed command. If the requested command is successfully validated, the routine 232 formulates a bed control signal in a format that can be processed by the bed component executing the bed command, and sends the bed control signal to the corresponding bed component (e.g. actuator, air supply, etc.).

For handwritten data entries, the routine 234 determines the corresponding data type using one or more of the techniques described above. The routine 236 verifies the data in accordance with the data type. For instance, if the routine 234 determines that the data type is the patient's body temperature, then if handwriting recognition and/or analysis routines determine that the handwritten input corresponds to the number “130,” the routine 236 will likely determine that the data entry is invalid.

For handwritten communications, the routine 238 creates a transmittable version of the handwritten communication. As illustrated, the routine 238 saves a copy of the handwritten communication to an image file. In other embodiments, the routine 238 may convert the handwritten communication to a text message using handwriting recognition and/or analysis software. The communication, whether in text or image form, or a notification thereof, is sent to the assigned caregiver by the routine 240. The caregiver assigned to the patient originator of the communication may be determined by accessing a look up table or other data structure that maps patient and assigned caregiver identifiers, which may be maintained by the nurse call system 86, by the EMR 84, or by another remote system.

Regardless of the input type, any and/or all of the handwritten input captured by the electronic writing tablets disclosed herein, or digital text counterparts thereof, may be stored in the memory 72 at the BCU 70, by the routine 242, and/or sent to the EMR system 84 or other remote system for further processing or storage, by the routine 244.

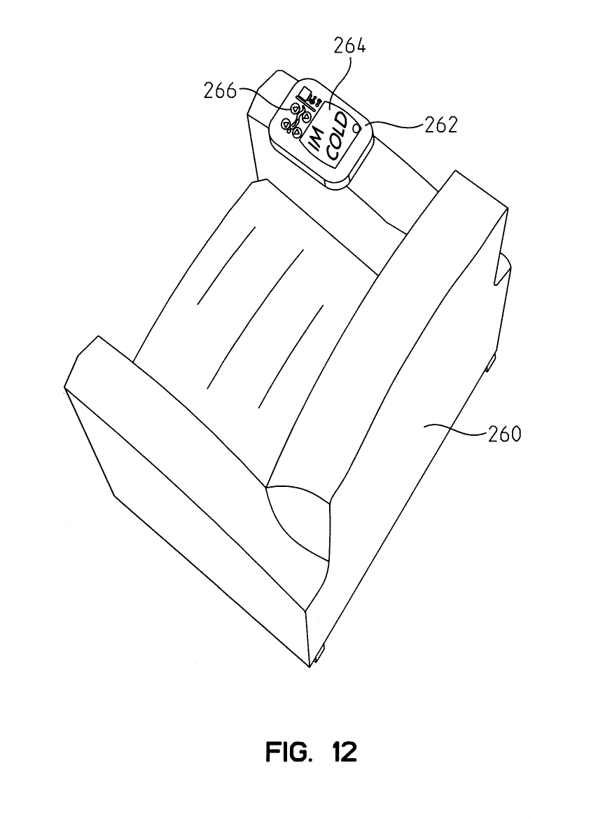

In FIG. 12, a chair 260 is shown with a user interface 262 incorporated therein. The user interface 262 includes an electronic writing tablet 264 as well as a number of hardpanel bed articulation controls 266. The electronic writing tablet 264 may have any of the features of the electronic writing tablets described above. The user interface 262 is configured to communicate electronically with the bed 10, e.g. by a wired or wireless, Ethernet or other type of suitable network connection.

There are many advantages of the present disclosure arising from the various features described herein. It will be noted that alternative embodiments of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A patient support system comprising:
a patient support having a plurality of features,
a control system coupled to the patient support and configured to electronically control at least one of the features of the patient support, and
an electronic writing tablet operably coupled to the control system, the electronic writing tablet comprising a surface configured to receive handwritten input in an electronic form, wherein the control system is configured to process the handwritten input received by the electronic writing tablet.

2. The patient support system of claim 1, wherein the control system controls an electronically controllable feature of the patient support in response to the handwritten input.

3. The patient support system of claim 1, wherein the control system stores the handwritten input in memory.

4. The patient support system of claim 1, wherein the control system sends the handwritten input to a remote system.

5. The patient support system of claim 1, wherein the control system associates the handwritten input with an input type and the input type is one of data, communication, and command.

6. The patient support system of claim 1, wherein the control system displays the handwritten input on at least one of a siderail, headboard, footboard, and pendant device coupled to the patient support.

7. The patient support system of claim 1, wherein the patient support is one of a headwall, footwall, table, support arm, column, and chair, and the electronic writing tablet is mounted to the patient support.

8. The patient support system of claim 1, wherein the patient support comprises a touchscreen graphical user interface and the electronic writing tablet is positioned adjacent the touchscreen graphical user interface.

9. A patient support comprising:
a base,
a frame supported by the base,
a deck supported by the frame and configured to support a person in a plurality of positions including a horizontal position, the deck comprising a plurality of articulating deck sections,
a user interface coupled to the frame, the user interface comprising an electronic writing tablet, the electronic writing tablet having a surface configured to receive and display handwritten input from a person situated on the patient support and/or a person not situated on the patient support, and
a control system operable to control at least one feature of the patient support and to process the handwritten input received by the electronic writing tablet.

10. The patient support of claim 9, wherein the user interface comprises a plurality of selectable controls each corresponding to a different type of handwritten input, and the selectable controls are positioned adjacent the electronic writing tablet.

11. The patient support of claim 10, wherein the control system associates the handwritten input with an input type and processes the handwritten input according to the input type.

12. The patient support of claim 9, wherein the user interface comprises an overlay supported by the surface of the electronic writing tablet, wherein the overlay comprises a graphical depiction of at least a portion of a patient support.

13. The patient support of claim 12, wherein the control system processes handwritten input displayed on the surface adjacent the graphical depiction of the patient support as a request to adjust a position of an articulating deck section of the patient support.

14. The patient support of claim 13, wherein the control system initiates the requested adjustment of the articulating deck section in response to the handwritten input.

15. The patient support of claim 9, wherein the control system associates the handwritten input with a corresponding data value and stores the corresponding data value in memory.

16. The patient support of claim 15, wherein the control system sends the data value to an electronic medical records system.

17. A control system for a bed, the control system configured to:
control an electronically-controllable feature of the bed,
receive handwritten input from an electronic writing tablet coupled to the bed,
determine an input type of the handwritten input, and
process the handwritten input according to the input type.

18. The control system of claim 17, configured to initiate the electronically-controllable feature of the bed if the input type indicates that the handwritten input is a command relating to the electronically-controllable feature of the bed.

19. The control system of claim 17, configured to associate the handwritten input with a corresponding data value if the input type indicates that the handwritten input is information.

20. The control system of claim 17, configured to receive handwritten input from multiple electronic writing tablets coupled to the bed.
